(19) United States
(12) Patent Application Publication
(10) Pub. No.: US 2016/0288270 A1
(43) Pub. Date: Oct. 6, 2016

(54) PREFORMS FOR BRAZING

(71) Applicant: HÖGANÄS AB (PUBL), Höganäs (SE)

(72) Inventors: Per KNUTSSON, Ängelholm (SE); Christophe SZABO, Ratingen (DE)

(73) Assignee: HÖGANÄS AB (PUBL), Höganäs (SE)

(21) Appl. No.: 15/038,293

(22) PCT Filed: Nov. 20, 2014
(86) PCT No.: PCT/EP2014/075146

§ 371 Date: May 20, 2016

(30) Foreign Application Priority Data
Nov. 22, 2013 (EP) 13194086.8

(51) Int. Cl. B23K 35/02; B23K 35/30; B22F 1/00

(52) U.S. Cl. CPC B23K 35/0244; B22F 1/0096; B23K 35/3033; B23K 35/3046; B23K 35/3053; B22F 1/0048; B22F 1/0062; C22C 1/0433

(57) ABSTRACT

A method for producing brazing preforms including the steps of providing an iron-, iron and chromium-, nickel- or cobalt-based spherical brazing powder. Converting the brazing powder into an agglomerated coarser powder suitable to be compacted into desired preforms and ejecting the preforms from the compaction die, the preforms having integrity and strength enough to let them be handled in an automated brazing line. Optionally, after ejecting from the compaction die, the preforms may be heat treated or subjecting to a sintering process if higher strength is desired. Also, the preform per se and a brazing process utilising the brazing preform.

### FIELD OF THE INVENTION

The present invention relates to brazing of articles which in use are subjected to elevated temperatures and brazing materials suitable for this purpose. In particular, the invention relates to a brazing material preform, made from iron-, iron and chromium, nickel or cobalt-based powders, having properties making the preform suitable to be handled in automated brazing processes. The present invention also relates to a method for producing the brazing preform as well as a brazing method.

### BACKGROUND OF THE INVENTION

In industry of today the need for automation of production processes in order to decrease cost and improve product quality is constantly raised. Especially in the automotive industry the degree of automated manufacturing is rapidly increased. In brazing technology another noticeable trend is that more and more brazed joints are subjected to elevated temperatures, hot gases, hot gas corrosion or highly corrosive media. Examples of objects which are affected by these trends are different kind of industrial, marine or automotive components. A typical application area is in combustion engines where Exhaust Gas Emission regulation EU6, has impact on e.g. heat exchangers for automotive applications and properties for e.g. brazing material used in the production thereof.

For these application areas conventional copper based brazing materials, which are formed by stamping of copper or copper alloyed sheets have properties not sufficient enough to withstand the high temperature, corrosive and mechanical loading environment present. Suitable brazing alloys for these applications are normally based on iron, iron-chromium, nickel or cobalt.

In contrast to brazing preforms made from stamped copper alloys having integrity and strength high enough to be handled in automated brazing lines, iron, iron-chromium, nickel or cobalt based brazing alloys cannot easily be provided in form of metal sheet having desired shape.

Brazing preforms are previously known in various applications, such as for braze-welding, described for example in EP0565750A1. This application reveals a method for forming preformed elements for braze-welding, the preforms containing a flux powder, a brazing alloy powder and an organic binder. The preformed element obtained by the described method is said to have any geometry and can be used in any flame, induction, resistance or furnace welding processes by which weld material (brazing alloy) is melted to join ferrous or non-ferrous metal parts (joining of pipes etc.) together. As previously mentioned, iron-, iron-chromium, nickel- or cobalt-based brazing materials are difficult to obtain in form of cast metal or sheets, as hard and brittle phases are easily formed. Such materials are normally made by atomization of a stream of molten metal, preferably by gas atomization, yielding a more or less fine spherical powder. Water atomization, which would give a more irregular powder shape, would be more beneficial when forming parts by compaction of the powder. Water atomization can however not be used when producing brazing powder as the method yields a powder having about 10 times higher oxygen content compared to gas atomization. A brazing powder material produced from gas atomization can easily be converted into a brazing paste, which however has some disadvantages when handled in an automated brazing line. A preferred shape would be a rigid preform made by compaction of the more or less spherical powder;

however until now it has been not possible to obtain such preform having strength enough due to the hardness and unsuitable shape of the powder.

### SUMMARY

The inventors of the present invention has unexpectedly found a solution to the above mentioned problem and provided a method for producing brazing preforms including the steps of providing an iron-, iron and chromium-, nickel- or cobalt-based spherical brazing powder. Converting the brazing powder into an agglomerated coarser powder suitable to be compacted into desired preforms and ejecting the preforms from the compaction die, the preforms having integrity and strength enough to let them be handled in an automated brazing line. Optionally, after ejecting from the compaction die, the preforms may be heat treated or subjecting to a sintering process if higher strength is desired. The present invention also provides the preform per se and a brazing process utilising the brazing preform.

### DETAILED DESCRIPTION

The powder used in the present invention is an iron-, iron and chromium-nickel- or cobalt-based brazing powder, i.e. a powder containing iron, iron and chromium, nickel or cobalt as main component, alloyed with other suitable allying elements giving desired mechanical properties and corrosion resistance to the brazed metal, melting point depressants and elements providing desired flowability properties to the melted brazing material. Examples of other suitable alloying elements are chromium, molybdenum, manganese, cobalt, vanadium, niobium, carbon. Typical melting point depressants which also may act as desired alloying elements and elements giving desired flowability properties during brazing are carbon, phosphorous, silicon, boron, manganese and sulphur.

Such powders are suitable to be used for brazing components when in use are subjected to temperatures where known copper or copper alloy brazing material are insufficient, i.e. at temperatures above 300° C. or 400° C. Embodiments of the present invention encompass iron and chromium-based powders alloyed with 11-35% by weight of chromium, 0-30% by weight of nickel, 2-20% by weight of copper, 2-6% by weight of silicon, 4-8% by weight of phosphorous, 0-10% by weight of manganese and at least 20% by weigh iron and further containing below 2% by weight of inevitable impurities. Embodiments of the present invention encompass nickel-based brazing powder alloyed with 6-8% by weight of chromium, 2.75-3.5% by weight of boron, 4-5% by weight of silicon and further containing below 2% by weight of inevitable impurities.

Other examples of nickel-based brazing powder are alloyed with 18.5-19.5% by weight of chromium, 9.75-10.50 and further containing below 2% by weight of inevitable impurities.

Still other examples of nickel-based brazing powder are alloyed with 13-15% by weight of chromium, 9.7-10.5% by weight of phosphorous and further containing below 2% by weight of inevitable impurities.

Still other examples of nickel-based brazing powder are alloyed with 27.5-31.5% by weight of chromium, 5.6-6.4% by weight of phosphorous, 3.8-4.2% by weight of silicon and further containing below 2% by weight of inevitable impurities.

Embodiments of the present invention encompass cobalt-based brazing powder are alloyed with 18-20% by weight of chromium, 0.7-0.9% by weight of boron, 7.5-8.5% by weight of silicon 3.5-4.5% by weight of tungsten, 0.35-0.45% by weight of carbon, up to 1% by weight of iron and further containing below 2% by weight of inevitable impurities.

Embodiments of the present invention encompass mixtures between alloyed powders as described above, and also mixtures between alloyed powders as described above and stainless steel powder 316L, copper powder, bronze powder or molybdenum powder.

The particle size of the powder used in the present invention is below 355 μm. (In the context of the present application “particle size below” means that 98% by weight of the particles have sizes below the value.)

In one embodiment the particle size of the powder is below 212 μm.

In yet another embodiment the particle size of the powder is below 150 μm.

In yet another embodiment the particle size of the powder is below 150 μm and the mean particle size between 70-120 μm.

In another embodiment the particle size of the powder is below 150 μm and having a mean particle size between 70-120 μm.

In another embodiment the particle size of the powder is below 106 μm and having a mean particle size between 40-70 μm.

According to another embodiment of the invention the particle size is typical below 63 μm having a mean particle size between 20-50 μm. The particle size distributions measured by standard sieve analysis according SS-EN 24497 or by Laser Diffraction according to SS-ISO 13320-1.

The shape of the particles is more or less spherical or round. The roundness as determined with a light optical microscope aided by Leica QWin software for image analysis is typically below 2 calculated by the formula; Roundness=Perimeter²/4Π*area*1.064, (1.064 being a correction factor). A value for the roundness of 1 corresponds to a perfect circle whereas an infinite value corresponds to a line.

A preferred iron-chromium-based powder is alloyed with 11-35% by weight of chromium, 0-30% by weight of nickel, 2-20% by weight of copper, 2-6% by weight of silicon, 4-8% by weight of phosphorous, 0-10% by weight of manganese and at least 20% by weigh iron and further containing below 2% by weight of inevitable impurities. The particle size distribution is typical below 63 μm having a mean particle size between 20-50 μm.

A preferred nickel-based powder is alloyed with 27.5-31.5% by weight of chromium, 5.6-6.4% by weight of phosphorous, 3.8-4.2% by weight of silicon and further containing below 2% by weight of inevitable impurities. The particle size distribution is typical below 63 μm having a mean particle size between 20-50 μm.

In order to obtain sufficient powder properties, i.e. flow and apparent density enabling the powder to be uniformly filled in a die cavity with sufficient filling rate and to efficiently incorporate a suitable binder to give the brazing preform integrity and strength, an agglomerating binder is added prior to the agglomeration process.

Any suitable water soluble binder may be used at an addition of 0.1-5%, preferably between 0.5-3%, most preferably between 0.5-2% by weight of the total powder and binder mixture. Examples of suitable water soluble binders are polyvinyl alcohol, polyethylene glycol having a molecular weight between 1 500 and 35 000, carboxymethylcellulose, methylcellulose, ethylcellulose, acrylates or gelatine. A preferred water soluble binder is polyvinyl alcohol. In addition, a non-water soluble binder such as a polyamide, a polyamide oligomer or a polyethylene, may be added. The total amount of water soluble binder and non-water soluble binder is between 0.1-5%, preferably between 0.5-3%, most preferably between 0.5-2% by weight of the total powder and binder mixture.

The agglomeration process may be a spray or freeze agglomeration process.

A preferred agglomeration process is freeze agglomeration process. The resulting agglomerates shall have an agglomerate size below 1 mm. In one embodiment the size of the agglomerates is below 500 μm.

In another embodiment the size of the agglomerates is below 500 μm and the median particle size between 50-180 μm, preferably between 75-150 μm.

The shape of the agglomerates is more or less spherical.

Optionally, the non-water soluble binder may be added to the agglomerated powder prior to compaction. In this case the total amount of binders will also be within the previous mentioned intervals for the total amount of water soluble binder and non-water soluble binder.

The agglomerated powder is filled in a suitable die and compacted into a brazing material preform at a compaction pressure of above 300 MPa, preferably between 400 MPa and 1000 MPa to a density of at least 3.5 g/cm³, preferably at least 4 g/cm³, more preferably at least 4.5 g/cm³ or even more preferably at least 5.0 g/cm³. The compaction press can be any unixail mechanical, hydraulic or electric driven compaction press. The ejected green brazing metal preform may optionally be subjected to a heat treating or sintering process.

A preferred heat treatment process comprises the steps of heating the preform up to a temperature above the softening point but below the decomposition temperature of the organic binder. For a polyamide or an amide oligomer the temperature is between 200° C. and 350° C., preferably between 225° C. and 300° C. For polyvinyl alcohol a preferred temperature interval is 125° C. and 200° C.

A preferred sintering process comprises the step of heating the preform in a protective atmosphere such as in vacuum or in nitrogen up to a temperature below the liquidus temperature of the material.

The weight of the brazing metal preform shall be chosen to give enough brazing metal to the components to be brazed and shape and strength enabling automated handling. The green strength according to the method described in SS-EN 23 995 shall be at least 0.5 MPa, preferably at least 1 MPa, most preferably at least 2 MPa. For brazing components where a toroid shaped preform is suitable, the ratio between the radius in cm to the weight in grams shall preferably be such that the weight is above 0.48*the radius in order to obtain sufficient strength of the preform.

Thus, the method for producing a brazing preform of the present invention comprises;
1. A method for producing a brazing preform comprising the steps of;
   Providing an iron-, iron and chromium-, nickel- or cobalt-based brazing powder having a particle size below 355 μm,
   mixing the powder with 0.1-5%, preferably between 0.5-3%, most preferably between 0.5-2% by weight of a water soluble binder chosen from the group of polyvinyl alcohol, polyethylene glycol having a molecular weight between 1 500 and 35 000, carboxymethylcellulose, methylcellulose, ethylcellulose, acrylates or gelatine and optionally adding and mixing in a non-water soluble binder chosen from the group of polyamides, amide oligomers and polyethylenes, the total amount of binders being 0.1-5%, preferably between 0.5-3%,
   subjecting the mixed powder to an agglomeration process resulting in an agglomerated powder having an agglomerated particle size below 1 mm,
   optionally adding a non-water soluble binder chosen from the group of polyamides, amide oligomers and polyethylenes, the total amount of binders being 0.1-5%, preferably between 0.5-3%,
   compacting the obtained agglomerated powder at a pressure of at least 300 MPa in an uniaxial compaction process to a density of at least 3.5 g/cm³
   optionally heat treat or sintered the compact,
   recover the obtained compacted preform,

In another aspect of the present invention it is provided a brazing preform made by the above described method.

In still another aspect of the present invention it is provided a brazing method based on use of a brazing preform including the steps of;
providing a brazing preform produced according to the method described above,
applying the brazing preform to any of the components to be brazed,
assembling the components to be brazed and,
subjecting the components to be brazed to any induction heating cycle, vacuum brazing process, resistance heating process or continuous furnace brazing process.

In one embodiment of the another aspect of the present invention described above the brazing method is used for brazing components when in use is subjected to temperatures above 300° C., preferably above 400° C.

### EXAMPLES

The following examples merely serve to illustrate the invention but are not supposed to be restricted thereto.

### Example 1

About 1 kg of a spherical nickel-based brazing powder was mixed with various amounts, according to table 1, of a fully hydrolysed polyvinyl alcohol (PVOH), having a molecular weight about 50 000.

The nickel based brazing powder was alloyed with 29.5% by weight of chromium, 5.9% by weight of phosphorous, 4.1% by weight of silicon and further contained below 2% by weight of inevitable impurities.

The particle size of the powder was below 63 μm and the median particle size between 20-50 μm.

TABLE 1

| Sample | A | B | C | D |
|---|---|---|---|---|
| % by weight | 0.5 | 0.5 | 1 | 3 |
| of PVOH | | | | |

The mixed samples were further subjected to a freeze agglomeration process in liquid nitrogen resulting in spherical agglomerates having a particle size less than 500 μm and a median particle size of about 120 μm. The obtained agglomerates were further subjected to a freeze drying step at reduced atmospheric pressure.

Agglomerates of sample B was further mixed with 1% of an amide oligomer, Orgasol®3501 from Arkema.

As reference material, Ref 1 and Ref 2, samples were prepared by mixing the non-agglomerated spherical nickel brazing powder with 2% and 3% respectively of Orgasol®3501.

Discs made from samples A-D, Ref1 and Ref2 were compacted at a compaction pressure of 600 MPa into discs having a diameter of 25 mm and height of 3 mm.

The agglomerated and the non-agglomerated powders were evaluated with respect to flow properties, i.e. the ability of the powder to uniformly fill the die cavity and the obtained compacted discs were evaluated with respect to strength. Results are shown in table 2.

TABLE 2

| | Sample | | | | | |
|---|---|---|---|---|---|---|
| | A | B | C | D | Ref1 | Ref2 |
| % by weight | 0.5 | 0.5 | 1 | 3 | — | — |
| of PVOH | | | | | | |
| % by weight | — | 1 | — | — | 2 | 3 |
| of oligomer | | | | | | |
| Flow | Good | Good | Good | Good | No flow | No flow |
| property | | | | | | |
| Strength of | Acceptable | Good | Good | Good | Acceptable | Good |
| compacted | | | | | | |
| disc. | | | | | | |

Table 2 shows that even at 0.5% by weight of PVOH acceptable strength of compacted disc was obtained. None of the reference samples exhibited acceptable flow properties.

### Example 2

Freeze agglomerated samples based on the powder used in Example 1 were prepared according to the method of Example 1. After the agglomeration process some of the samples were further mixed with an amide oligomer according to Example 1. The following table 3 shows the binders used.

TABLE 3

| Sample | E | F | G | H |
|---|---|---|---|---|
| % by weight | 0.5 | 2 | 0.5 | 1 |
| of PVOH | | | | |
| % by weight | — | — | 1 | 3 |
| of oligomer | | | | |

Toroid shaped preforms having outer diameter of 55 mm, inner diameter of 47 mm and height of 3 mm were compacted at a compaction pressure of 600 MPa. The obtained toroid preforms were evaluated with respect to strength and handling properties.

The samples were also evaluated with respect to brazing properties by placing a preform on a 316L stainless 1.0 mm steel plate, heating the preform and plate under vacuum furnace to a temperature of 1080° C. when all the brazing material has melted. The cooled samples were examined with respect to brazing appearance such as flowability, i.e. the ability of the brazing material in melted state to cover the steel plate and the visual appearance of the braze after cooling.

TABLE 4

| Sample | E | F | G | H |
|---|---|---|---|---|
| % by weight | 0.5 | 2 | 0.5 | 1 |
| of PVOH | | | | |
| % by weight | — | — | 1 | 3 |
| of oligomer | | | | |
| Strength | Acceptable | Good | Good | Good |
| Brazing | Good | Good | Some carbon | Some carbon |
| appearance | | | containing | containing |
| | | | residues after | residues after |
| | | | braze test. | braze test. |

Table 4 shows that all samples worked. For some applications a carbon containing residue after brazing may be acceptable, however, braze test of sample G and H indicates somewhat inferior brazing appearance.

### Example 3

Green strength samples according to SS-EN 23 995 were produced by compacting the samples A-D at a compaction pressure of 600 MPa. The obtained green strength and densities are shown in table 5.

TABLE 5

| Sample | A | B | C | D |
|---|---|---|---|---|
| % by weight | 0.5 | 0.5 | 1 | 3 |
| of PVOH | | | | |
| % by weight | — | 1 | — | — |
| of oligomer | | | | |
| added after | | | | |
| agglomeration | | | | |
| Green | 0.9 | 1.7 | 2.6 | 4.3 |
| Strength MPa | | | | |
| Density g/cm³ | 5.35 | 5.38 | 5.37 | 5.38 |

Table 5 shows that all samples exhibited green strength above 0.5 MPa.

1. A method for producing a brazing preform comprising the steps of:
providing an iron-, iron and chromium-, nickel- or cobalt-based brazing powder having a particle size below 355 μm,
mixing the powder with 0.1-5% by weight of a water soluble binder chosen from the group of polyvinyl alcohol, polyethylene glycol having a molecular weight between 1500 and 35000, carboxymethylcellulose, methylcellulose, ethylcellulose, acrylates or gelatine and optionally adding and mixing in a non-water soluble binder chosen from the group of polyamides, amide oligomers and polyethylenes, the total amount of binders being 0.1-5%
subjecting the mixed powder to an agglomeration process resulting in an agglomerated powder having an agglomerated particle size below 1 mm,
optionally adding a non-water soluble binder chosen from the group of polyamides, amide oligomers and polyethylenes, the total amount of binders being 0.1-5%, preferably between 0.5-3%,
compacting the obtained agglomerated powder at a pressure of at least 300 MPa in an uniaxial compaction process to a density of at least 3.5 g/cm³
optionally heat treating or sintering the compact,
recovering compacted preform.

2. The method according to claim 1 wherein the iron-, iron-chromium-, nickel or cobalt-based powder has a particle size below 212 μm.

3. The method according to claim 1 wherein the iron-, iron-chromium-, nickel or cobalt-based powder has a particle size below 150 μm.

4. The method according to claim 1 wherein the iron-, iron-chromium-, nickel or cobalt-based powder has a particle size below 150 μm and a mean particle size between 70-120 μm.

5. The method according to claim 1 wherein the iron-, iron-chromium-, nickel or cobalt-based powder has a particle size below 106 μm and a mean particle size between 40-70 μm.

6. The method according to claim 1 wherein the iron-, iron-chromium-, nickel or cobalt-based powder has a particle size below 63 μm and a mean particle size between 20-50 μm.

7. The method according to claim 1 wherein the powder is an iron-based powder.

8. The method according to claim 1 wherein the powder is an iron and chromium-based powder.

9. The method according to claim 1 wherein the powder is a nickel-based powder.

10. The method according to claim 1 wherein the powder is a cobalt-based powder.

11. The method according to claim 1 wherein the water soluble binder is polyvinyl-alcohol.

12. The method according to claim 1 wherein the non-water soluble binder is an amide oligomer.

13. A brazing preform obtained by the method according to claim 1.

14. A brazing process for brazing components comprising the steps of:
providing a brazing preform according to claim 13,
applying the brazing preform to any of the components to be brazed,
assembling the components to be brazed and,
subjecting the components to be brazed to any induction heating cycle, vacuum brazing process, resistance heating process or continuous furnace brazing process.

15. A brazing process according to claim 14 for brazing components when in use are subjected to temperatures above 300° C.
